(19) United States
(12) Patent Application Publication
(10) Pub. No.: US 2011/0167669 A1
(43) Pub. Date: Jul. 14, 2011

(54) WALL DRYING METHOD AND APPARATUS

(76) Inventor: Mark E. Pedersen, San Diego, CA (US)

(21) Appl. No.: 13/071,012

(22) Filed: Mar. 24, 2011

Related U.S. Application Data
(62) Division of application No. 12/246,359, filed on Oct. 6, 2008.
(60) Provisional application No. 60/977,765, filed on Oct. 5, 2007.

(51) Int. Cl. F26B 3/02; F26B 3/00

(52) U.S. Cl. 34/475; 34/443

(57) ABSTRACT

A system for drying walls includes a panel which has a first portion, a second portion, and a body portion, the body portion joining the first portion and the second portion, the first portion being in contact with a floor and the second portion being in contact with a wall, the panel creating a channel through which air is passed to extract water from the wall. A method of drying lower portions of walls within a water-damaged building includes placing a plurality of panels against the lower portions of walls such that a channel is created along the lower portions of the walls and forcing air along the channel.

### BACKGROUND

A variety of situations can arise where it can be desirable to control the humidity levels and water content of materials within a building or other enclosed area need to be controlled. For example, when a building has been flooded or otherwise water damaged, removing water from the materials and air within the building is critical for the prevention of further damage to the material and to prevent the unwanted growth of microorganisms and mold inside the building. If the water is promptly removed from the building by drying out carpets, floors, walls, and other wet items, many of the effects of the unwanted water can be minimized. However, if no efforts are taken to accelerate the drying process, wood framing and drywall may take from several months to several years to dry out, depending on saturation levels. When the conditions are right, mold growth may start in a couple of days, making it important that accelerated drying be started as promptly as possible and remove the water as quickly as possible.

Walls are particularly difficult to dry because they contain enclosed areas that trap moisture, as well as materials that absorb and retain water. For example, the spaces in between studs in a wall create void where water can be trapped. Often the spaces in between the studs are filled with insulation or sound proofing, which absorb and retain water. Many popular wall coverings, such as dry wall, absorb and are easily damaged water.

One method of gaining access to the interior of a wall involves removing the saturated drywall to allow air to circulate through cavities in walls. This destroys the drywall, paint and other decor. Replacing these interior building elements is expensive and time consuming.

If the portions of the building interior that contain significant moisture can be rapidly dried, further water damage and mold growth can be avoided. Ideally, this drying would occur without removing the drywall from the building walls.

In many situations, the unwanted water does not fill the entire building, but is only a few inches to several feet deep. The primary areas that need to be dried are the floor and the lower portions of the walls. One method of rapidly drying the interior of a building involves heating the interior air. By heating the interior air of a building, the temperature of the interior objects increases, encouraging the evaporation of the water they contain. Heating the interior air also increases the air's ability to absorb the water vapor. As the water evaporates from the materials, the heated air carries the water vapor out of the building by means of fans. Additionally, the growth of mold and other microbes are discouraged by air temperatures above about 90 degrees Fahrenheit. Heating the building's interior can be combined with dehumidifiers to speed the evaporation and drying.

### BRIEF DESCRIPTION OF THE DRAWINGS

The accompanying drawings illustrate various embodiments of the present system and method and are a part of the specification. The illustrated embodiments are merely examples of the present system and method and do not limit the scope thereof.

FIGS. 1A and 1B illustrate a front and a side view, respectively, of an illustrative straight wall panel, according to one embodiment of principles described herein.

FIGS. 2A and 2B illustrate a front and a side view, respectively, of an illustrative corner panel, according to one embodiment of principles described herein.

FIGS. 3A and 3B illustrate a front and a side view, respectively, of an illustrative straight wall panel, according to one embodiment of principles described herein.

FIGS. 4A and 4B illustrate a front and a side view, respectively, of an illustrative corner panel, according to one embodiment of principles described herein.

FIGS. 5A and 5B illustrate a front and a side view, respectively, of an illustrative cross door panel, according to one embodiment of principles described herein.

FIGS. 6A and 6B illustrate a front and a side view, respectively, of an illustrative end block, according to one embodiment of principles described herein.

FIG. 7 is a cross-sectional diagram of illustrative straight wall panel in place against a water damaged wall, according to one embodiment of principles described herein.

FIG. 8 is a cross-sectional diagram of illustrative straight wall panels placed on either side of a water damaged wall, according to one embodiment of principles described herein.

FIG. 9 is a cross-sectional diagram of an illustrative straight wall panel in place against a water damaged wall, according to one embodiment of principles described herein.

FIG. 10 is a cross-sectional diagram of an illustrative straight wall panels placed on either side of a water damaged wall, according to one embodiment of principles described herein.

FIG. 11 is a top view of illustrative system of panels configured to dry the bottom portion of walls within a building, according to one embodiment of principles described herein.

FIG. 12 is a top view of illustrative system of panels configured to dry the bottom portion of walls within a building, according to one embodiment of principles described herein.

Throughout the drawings, identical reference numbers designate similar, but not necessarily identical, elements.

### DETAILED DESCRIPTION

Heating the entire interior of a building is more expensive and slower than heating only the areas within the building that contain significant excess moisture. By heating only the portion of the wall that contains significant excess moisture, the walls can be more rapidly dried and damage to the walls and interior can be minimized. According to one illustrative embodiment, a number of panels rest on the floor and are leaned against the wall, creating a confined area at the base of the wall which has absorbed water near its base. Heated and/or dehumidified air is passed through the confined area, rapidly and effectively drying the saturated portions of the wall.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

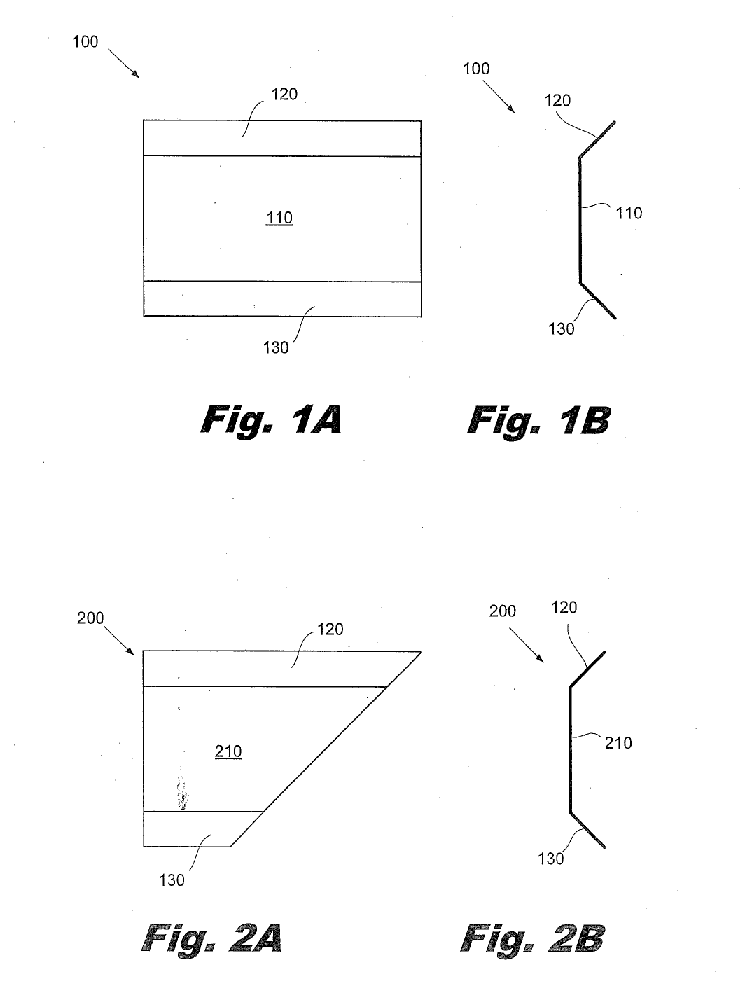

FIGS. 1A and 1B illustrate a straight wall panel (100), according to one illustrative embodiment. As illustrated in FIG. 1, the straight wall panel (100) is comprised of a generally rectangular body (110) that has the top and bottom edges bent to an obtuse angle, forming a top flange (120) and a bottom flange (130). In one illustrative embodiment, the obtuse angle is about 135 degrees. The length of the straight wall panel (100) can vary according to the material it is made from, convenience in transporting and using the panel, and the specific circumstances under which it is used. In one illustrative embodiment, the panel (100) is about four feet long.

The panel (and other panels described herein) can be made from a variety of materials including plastics or other polymers, wood, metal, composite materials or other suitable material.

FIGS. 2A and 2B show a corner panel (200) according to one illustrative embodiment. As illustrated in FIG. 2A, the corner panel (200) is comprised of a body (210) cut at an angle such that one corner of the body is removed. The top and bottom edges are bent to an obtuse angle, forming a top flange (120) and a bottom flange (130). In one illustrative embodiment, the obtuse angle is about 135 degrees. The obtuse angles of the flanges (120, 130) in the straight panels (100) and corner panels (200) allow a plurality of panels to be nested together for compact storage and transportation.

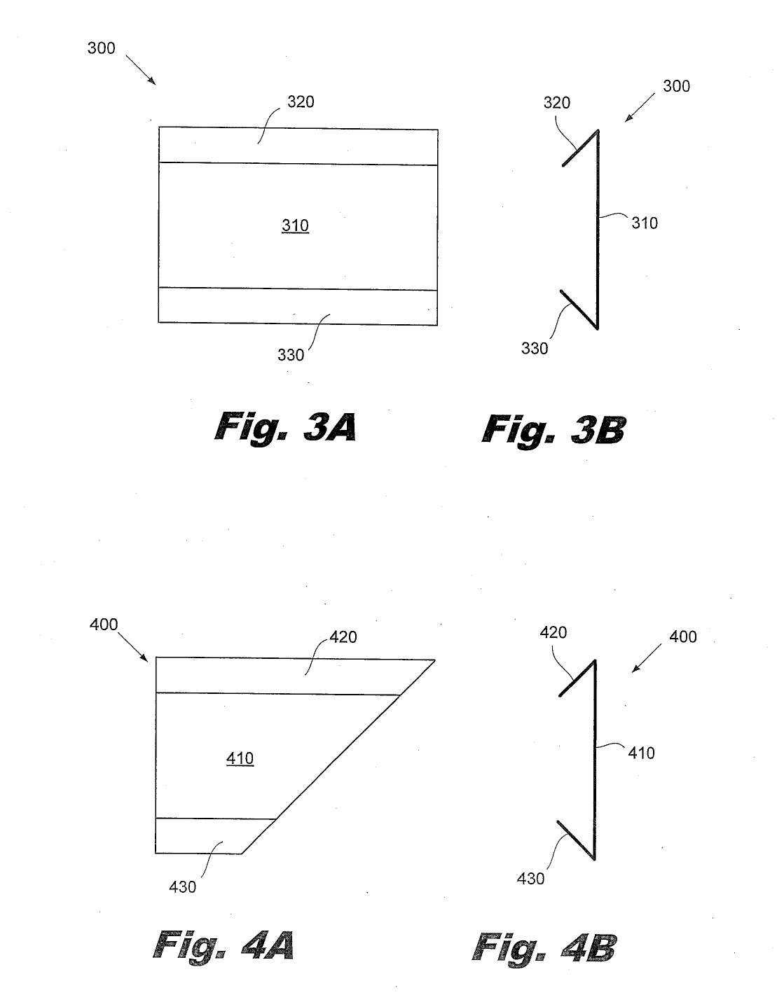

FIGS. 3A and 3B illustrate an alternative embodiment of a straight wall panel (300), according to one illustrative embodiment. As illustrated in FIG. 3, the straight wall panel (300) is comprised of a generally rectangular body (310) that has the top and bottom edges bent to an acute angle, forming a top flange (320) and a bottom flange (330). In one illustrative embodiment, the obtuse angle is about 45 degrees.

FIGS. 4A and 4B show a corner panel (400) according to one illustrative embodiment. As illustrated in FIG. 4A, the corner panel (400) is comprised of a body (410) cut at an angle such that one corner of the body is removed. The top and bottom edges are bent to an acute angle, forming a top flange (420) and a bottom flange (430). In one illustrative embodiment, the obtuse angle is about 45 degrees.

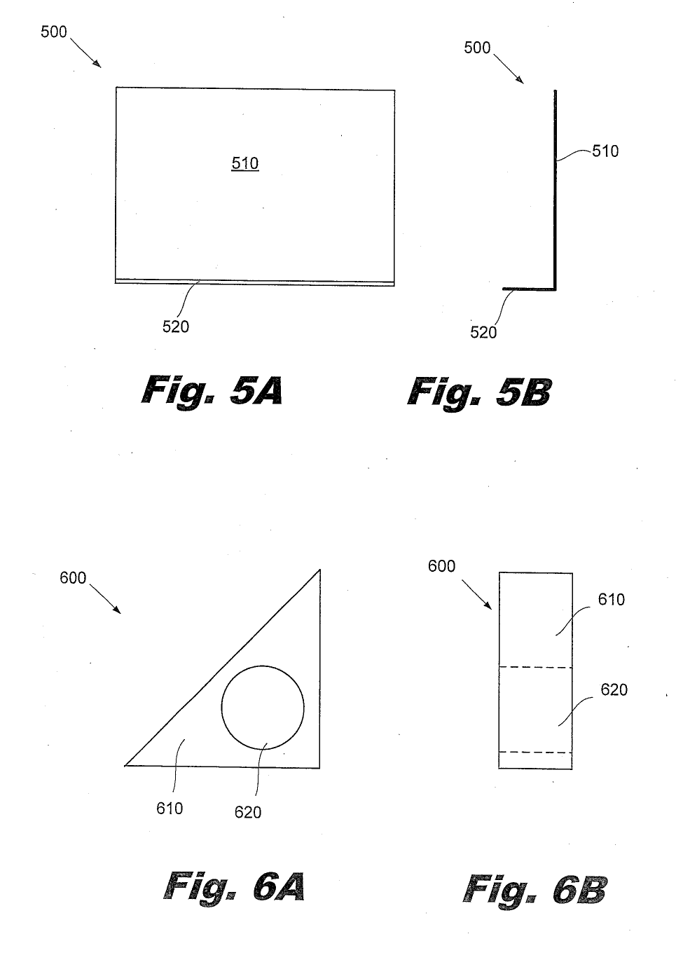

FIGS. 5A and 5B show an across door panel (500) according to one illustrative embodiment. As illustrated in FIG. 5, the across door panel (500) is comprised of a generally rectangular body (510) with the bottom edge bent perpendicular to main portion of the body to form a bottom extension (520).

The flanges (120, 130, 320, 330, 520) can be covered with felt or other conformable material to protect the wall and floor. The felt or other conformable material also can reduce leakage of heated and/or dehumidified air.

Further the body panels (110, 210, 310, 410, 510) can be stiffened by introducing a variety of stiffening geometries or materials. According to one illustrative embodiment a series of corrugations or indentations is used to stiffen the body of the panels. For example an “X” shaped indentation could be formed across the body to increase its rigidity.

FIGS. 6A and 6B show an end plug (600) according to one illustrative embodiment. As illustrated in FIG. 6, the end plug (600) is comprised of a generally right triangular body (610) with a central bore (620) that passes through the thickness of the body (610).

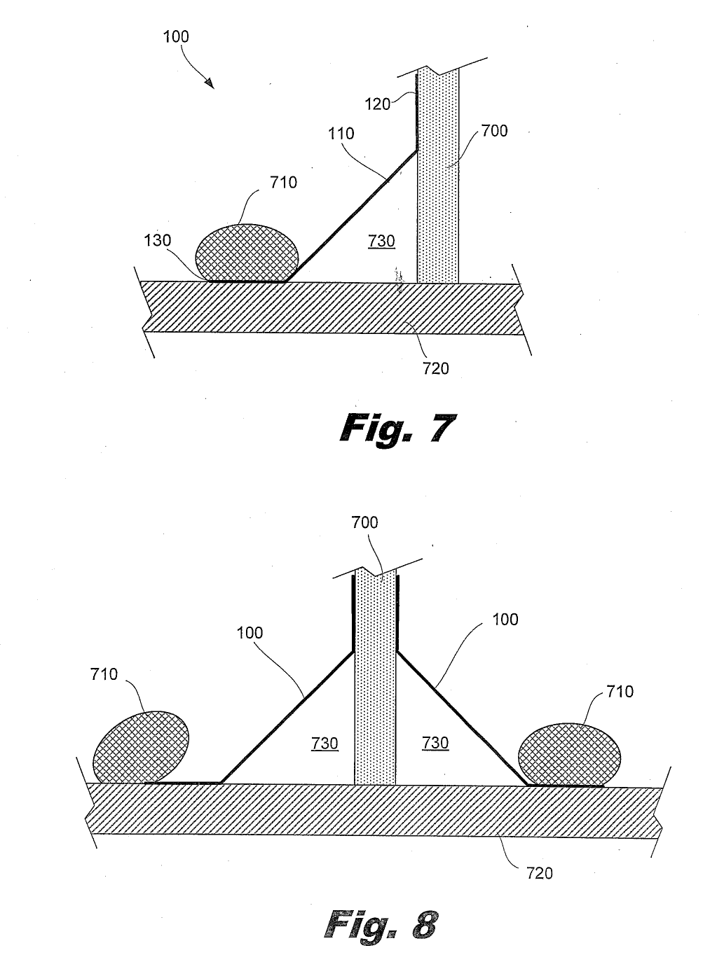

FIG. 7 is a cross-sectional diagram of a straight wall panel (100) in place against a water damaged wall (700). The top flange (120) rests against the wall (700) and the bottom flange (130) rests against the floor (720). The body (110) creates an enclosed area that is configured to contain and route heated and/or dehumidified air through the cavity (730) defined by the wall surface, the floor surface and the body (110). A sand bag (710) can be placed on the bottom flange (130) to hold the straight wall panel (100) in place.

One particular disadvantage of heating the entire interior of a building is that the hottest air rises to the ceiling, whereas the majority of the moisture is typically contained at or near the floor. Consequently, temperature of the building must be significantly higher to effectively dry the lower portions of the walls. Further, increasing heating the entire building consumes a significant amount of energy and the heat can make working within the building oppressive. The panels create a channel (730) that efficiently delivers and retains energy in the walls, while maintaining a tolerable working environment for other restoration efforts.

Further the motion of the air is important in drying. By creating a cavity along the bottom of a wall, the air motion can be controlled and particularly directed to the bottom portion of the wall where the majority of the moisture is contained.

It is understood that the straight wall panel and other panels described in this specification can be oriented in a variety of orientations and that the particular orientation that is illustrated or described is for convenience of explanation, not to limit the scope of the invention. For example, the straight wall panel is horizontally and vertically symmetrical, which allows it to be placed against the wall with the top flange resting against the wall or the floor.

Further the straight wall panel (and all other panels described in the specification) can be held in place in a variety of methods, including using sand bags as described. By way of example and not limitation, the panels may be held in place by tape, adhesive, weights, wedges, friction, spring mechanisms, magnets, clamps, or other means.

FIG. 8 is a cross-sectional diagram of straight wall panels (100) placed on either side of a water damaged wall (700), according to one illustrative embodiment. By placing the straight wall panels on either side of the damaged wall (700), the wall can be dried from both sides. This accelerates the removal of the water, minimizing damage to the wall components and inhibiting the growth of mold.

FIG. 9 is a cross-sectional diagram of an alternative embodiment of the straight wall panel (300) in place against a water damaged wall (700). The top flange (320) rests against the wall (700) and the bottom flange (330) rests against the floor (720). The body (310) creates an enclose area that is configured to contain and route heated and/or dehumidified air through the cavity (730) defined by the wall surface, the floor surface and the body (310). A sand bag (710) can be placed on the bottom flange (330) to hold the straight wall panel (300) in place.

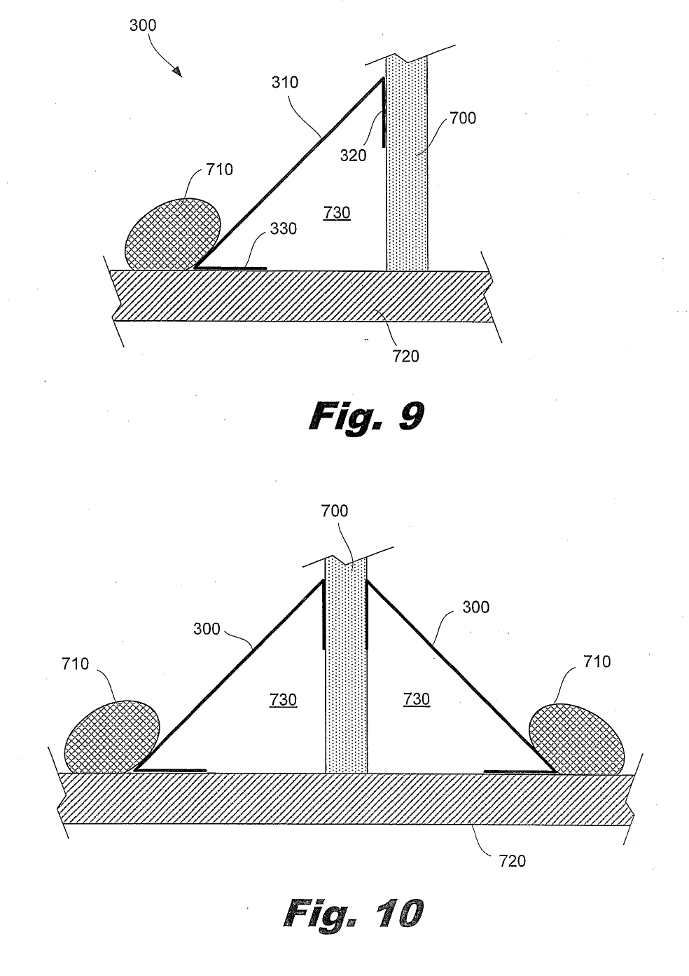

FIG. 10 is a cross-sectional diagram of straight wall panels (300) placed on either side of a water damaged wall (700), according to one illustrative embodiment. By placing the straight wall panels on either side of the damaged wall (700), the wall can be dried from both sides. This accelerates the removal of the water, minimizing damage to the wall components and inhibiting the growth of mold.

The use of panels (300) that include flanges (320, 330) with acute angles further concentrates the air contact with the lower portion of the wall, while allowing a large volume of air to pass through the cavity (730). This configuration may be particularly useful where the saturated materials confined to the extreme lower portions of the wall (700).

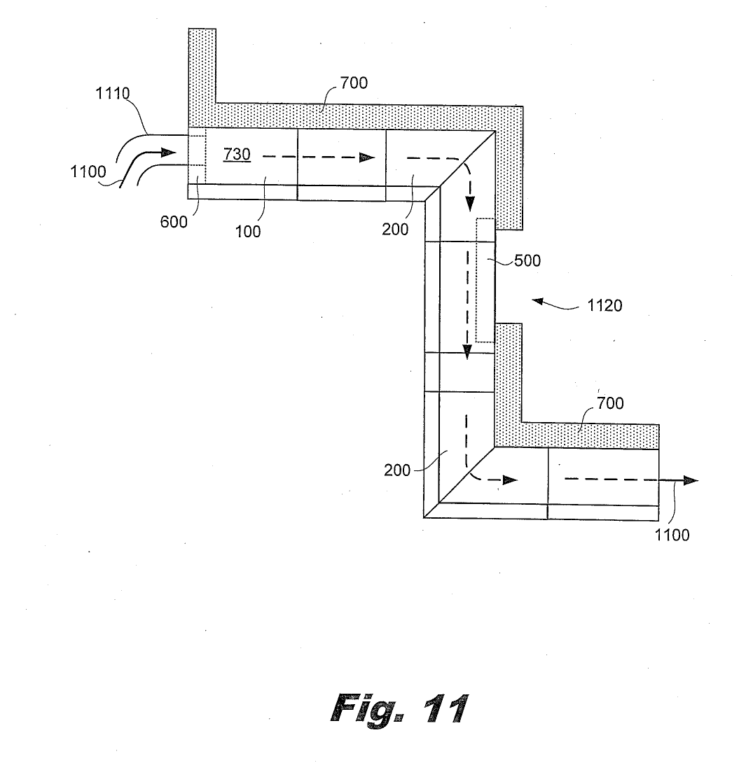

FIG. 11 is a top view of illustrative system of panels configured to dry the bottom portion of walls within a building, according to one illustrative embodiment. As illustrated in FIG. 11, heated and/or dehumidified air (1100) is created and routed through a duct (1110) that is connected to the end plug (600). The central bore of the end plug is configured to receive the duct (1110). The air then enters the cavity (730) created by placing straight wall panels against a water damaged wall (700). The air continues to be routed through the cavity (730) which is created by placing additional panels against the wall. In interior corners, two corner panels (200) are used. The portions of the body (210) that are cut at an angle join to create a 90 degree turn in the cavity (730) that matches the 90 degree interior angle of the wall. As the cavity approaches a doorway, a cross door panel (500) is used to contain the air and substitute for the wall (700) in creating the cavity.

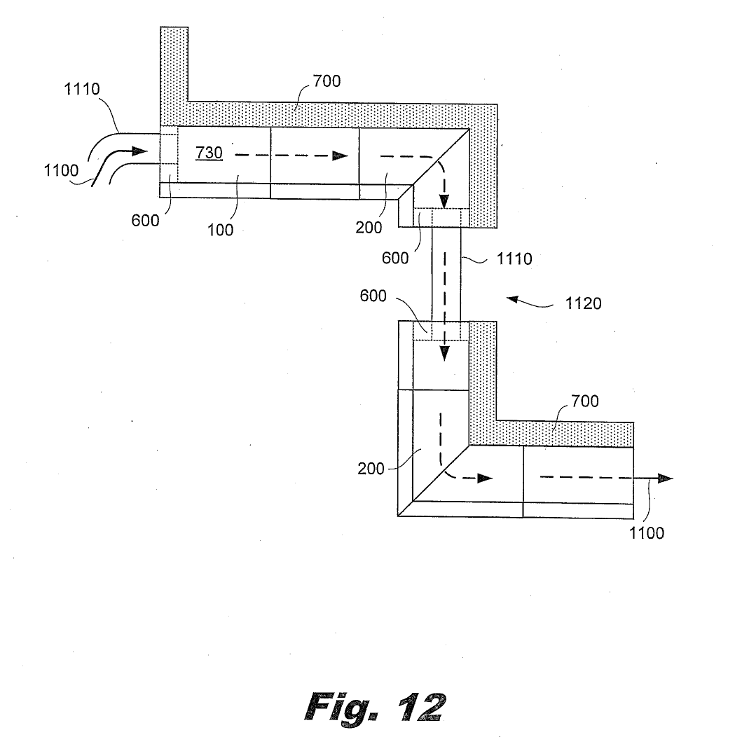

FIG. 12 is a top view of illustrative system of panels configured to dry the bottom portion of walls within a building, which shows an alternative method of spanning a doorway (1120). According to this embodiment, the panels (100, 500) do not span the doorway, allowing increased access through the doorway. Instead, an end plug (600) is inserted into the panels on either side of the door. A duct (1200) is inserted into each of the end plugs (600). The duct (1200) conveys the heated and/or dehumidified air (1100) across the doorway (1120) and from one section of panels to the next section of panels. The duct (1200) is more flexible and has a lower profile than sections of panels, improving access through the doorway.

The advantages of this system of panels that are leaned up against the walls to create a cavity includes: fast set up; easy and compact storage; retention of heat against the wall surface; reduction of energy required to dry the walls; quicker wall drying times; work can continue in building; and the system includes an efficient method of exhausting the exit air from the building. Further, the panels can be held in place in any one of a variety of methods and the system easily adapts to the contours of walls, including interior and exterior corners and doorways.

The preceding description has been presented only to illustrate and describe embodiments and examples of the principles described. This description is not intended to be exhaustive or to limit these principles to any precise form disclosed. Many modifications and variations are possible in light of the above teaching.

1-20. (canceled)

21. A method of drying lower portions of walls within a water-damaged building comprising: placing a plurality of panels against lower portions of walls such that an enclosed channel is created along said lower portions of said walls, and
introducing air into said enclosed channel and forcing air along said channel.

22. The method of claim 21, wherein said air is heated and dehumidified.

23. The method of claim 21, further comprising placing an end plug into an opening of said channel, said end plug substantially filling a cross section of said channel and having an aperture passing through the thickness of said end plug, said aperture providing access to said channel, said aperture being configured to receive a duct.

24. The method of claim 23, further comprising forcing said air through said duct and into said channel.

25. The method of claim 21, further comprising spanning a doorway by placing a cross door panel in said doorway to maintain continuity of said channel.

26. The method of claim 21, further comprising spanning a doorway by placing a first end plug in a channel on a first side of said doorway; placing a second end plug in a channel on a second side of said doorway; inserting a first end of a duct into said first end plug; and inserting a second end of said duct into a second end plug.

27. The method of claim 21, further comprising anchoring said panels in place using a weight.

28. The method of claim 21, further comprising forming a channel around a corner of said wall by placing a first corner panel and a second corner panel, said first corner panel and said second corner panel being substantially identical, said first corner panel and said second corner panel being joined to form a channel in an interior corner of said wall.

29. The method of claim 28, wherein said first corner panel and said second panel are configured to be reoriented to form a channel around an exterior corner of said wall.
